(19) United States
(12) Patent Application Publication
(10) Pub. No.: US 2013/0292948 A1
(43) Pub. Date: Nov. 7, 2013

(54) MONOBEARING EOLIC TURBINE WITH RADIAL FLOW ELECTRIC GENERATOR AND EXTERNAL STATOR

(71) Applicants: Fabio Pallotti, Magione (IT); Matteo Laghi, Forli' (IT); Luca Espis, Predappio (IT)

(72) Inventors: Fabio Pallotti, Magione (IT); Matteo Laghi, Forli' (IT); Luca Espis, Predappio (IT)

(73) Assignee: TREVI ENERGY S.p.A., Cesena (FC) (IT)

(21) Appl. No.: 13/575,790

(22) PCT Filed: Jan. 24, 2011
(86) PCT No.: PCT/IB2011/000092

§ 371 Date: Jun. 11, 2013

(30) Foreign Application Priority Data
Jan. 29, 2010 (IT) TO2010A000059

(51) Int. Cl. F03D 9/00

(52) U.S. Cl. CPC F03D 9/002
USPC 290/55

(57) ABSTRACT

A wind turbine (1) with an external stator generator includes a tower (20), a shuttle (30) positioned on the tower (20), a wind rotor (50) having at least one blade (51) hit by a wind flow, and an electric generator (40) for producing an electric current from the wind flow mounted inside the shuttle (30). The generator (40), of the radial flow kind, includes a stator (41) and a rotor (42); the stator (41) being external to the rotor (42); the wind turbine (1) including a support bearing (60) of the wind rotor (50) and of the rotor of the generator (42). The bearing (60) includes a first and second ring (61, 62); the first ring (61) being fixed with respect to the shuttle (30); the second ring (62) rotating with respect to the shuttle (30); the bearing (60) being installed in a stress relief position of at least one part of the frame of the generator (31).

The present invention relates to the field of wind generators and in particular it relates to a wind turbine with a radial flow and external stator electric generator.

From WO0121956 mono-bearing wind generators with direct transmission (“direct drive”) are known, provided with a shuttle in which a radial flow generator with inner stator is positioned; the shuttle being positioned on the top of a tower and the stator integral with the shuttle, whereas the rotor, externally to the stator, is connected to the blades of a wind rotor provided with a plurality of blades and is moved by the wind.

The wind generator shown in WO0121956 is characterized by some disadvantages. In particular it has a rotor support structure (externally to the rotor structure) with relevant encumbrances caused by the great radial distance with respect to the rotary axis of the rotor. Therefore this configuration needs a very rigid rotor support structure also in order to face the great stresses generated on the rotor, among which those due to tangential forces caused by the electromagnetic interaction between rotor and stator and to the inertial forces. Furthermore, having an inner electric stator entails not negligible cooling problems. Therefore the realization of a mechanically robust electric generator not because of the intrinsic power of the generator, but to withstand the forces developing during the rotation of the wind turbine due to the wind (force of gravity, inertial, tangential or radial forces due to the wind effect), imposes construction constraints on the generator itself which do not permit its optimization in terms of yield making it uneconomical.

The alternative configuration of the same machine (always shown in WO0121956) provides the support of the external stator and that of the inner rotor. In this configuration, the external stator support has to be remarkably rigid; the stator support therefore becomes very costly to produce. Furthermore, the rotor support is directly connected, with the movable ring of the bearing and with the wind rotor by means of a “single simplified connection” or elementary connection. All the rotary components forming the kinematic chain therefore require their assembly by means of such a connection, even before the installation of the machine. Due to the consequent great encumbrances and weight, the limits of the machine dimensions are therefore obvious.

From US 2009/0026771 a wind turbine of the mono-bearing direct-transmission kind is also known, having an electric generator provided with an external stator and a rotor directly coupled with the wind rotor (hub) of the turbine through a simplified connection (without a revolution multiplier) and through a single flange. The connection shown in the aforementioned document provides for a coupling form between the rotor support structure, the rotary external ring of the bearing and the hub of the wind turbine; such a coupling has the disadvantage not to be of the isostatic kind, in the case the hub is not previously assembled, as in order to assemble and transport the turbine that is the subject of the aforementioned invention, it is necessary to assemble also the hub taking the bearing in an axial stroke; the assembling must necessarily take place through auxiliary connections which impose some constraints, both of the constructive point of view and of the transport point of view. In detail, such a configuration requires therefore that the assembling of the hub with the electric generator happens on the ground, causing obvious limits from the logistic point of view in the transport and installation steps of the wind generator, and by imposing also heavy size restrictions of the generator itself.

In the aforesaid document, also, an external, non-flanged rotary ring is shown, which in case of elastic deformations during its operation, increases the danger of fretting corrosion. Furthermore, in order to perform some bench tests of the electric generator here shown, it is necessary to fasten the rotor of the generator with a bearing, which can be fastened only if also the hub is mounted, or only if the use of a temporary closing tool between the bearing-rotor assembly and the generator is provided.

In DE 102 55 745 a wind machine of the direct drive kind is described, in which the electric generator is supported in an asymmetric way, by a structure joining the generator to the tower.

The aim of the present invention is therefore to describe a direct transmission wind turbine with an external stator electric generator, which solves the previous drawbacks and is supported in a symmetric way.

According to the present invention, a wind turbine with an external stator electric generator according to claim 1 is realized.

The invention will be now described with reference to the annexed drawings, illustrating a non-limitative embodiment, in which:

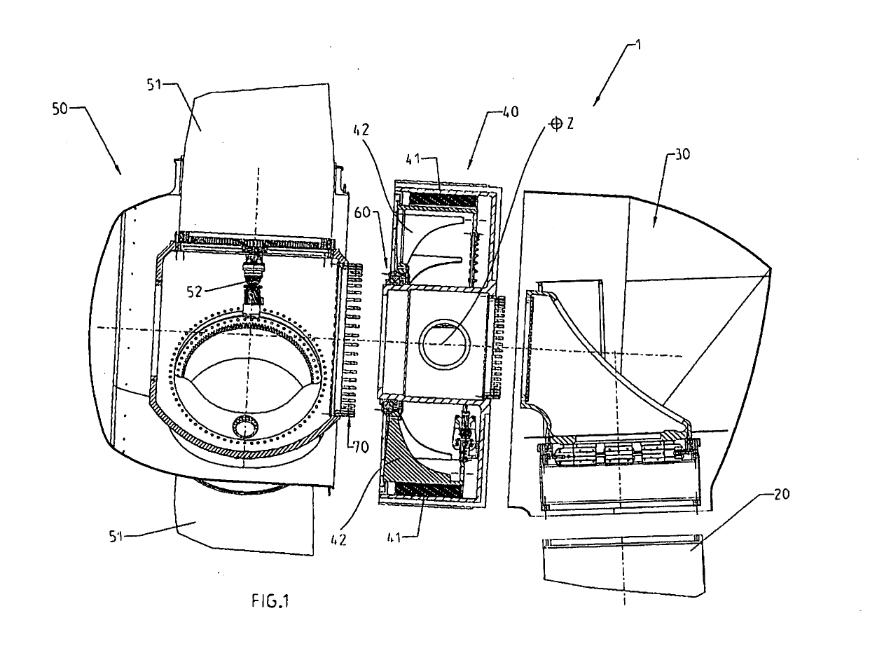

FIG. 1 shows a perspective exploded view of a part of the wind turbine with an external stator generator according to the present invention; it has to be noted that the exploded view underlines the assembly sequence in the installation steps of the turbine;

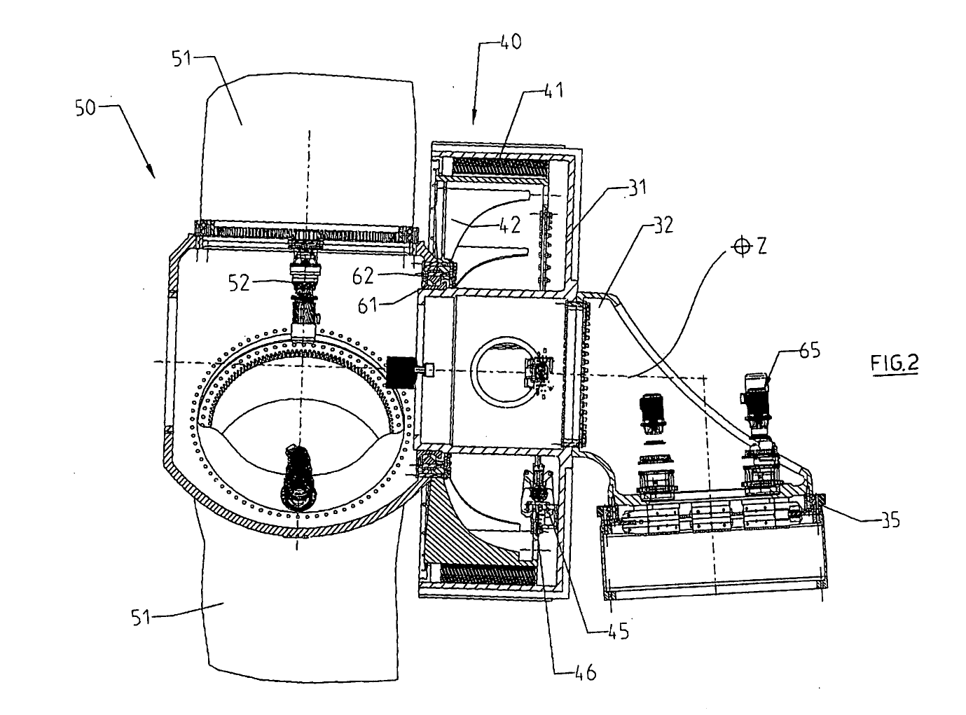

FIG. 2 shows a detail of a part of the generator in FIG. 1;

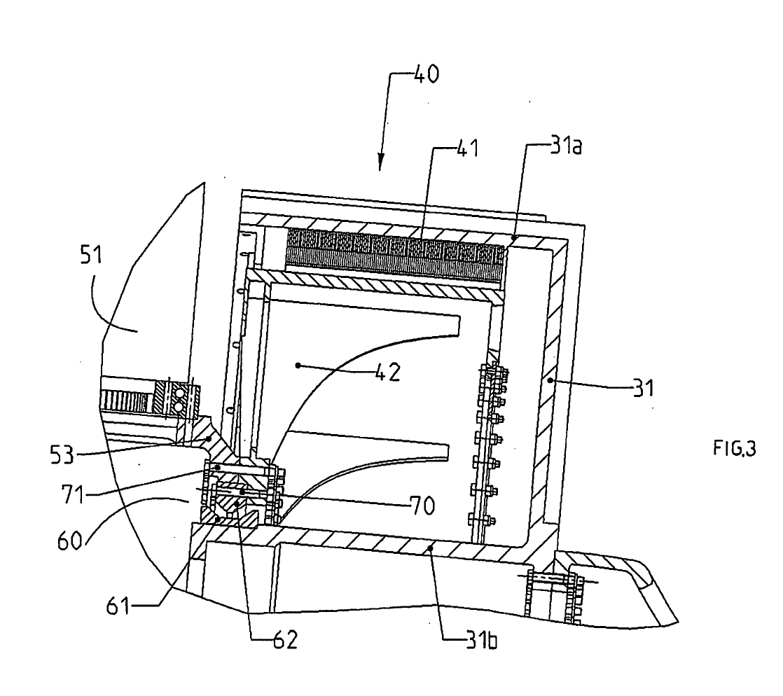

FIG. 3 shows a detail of a part of the generator in FIG. 2;

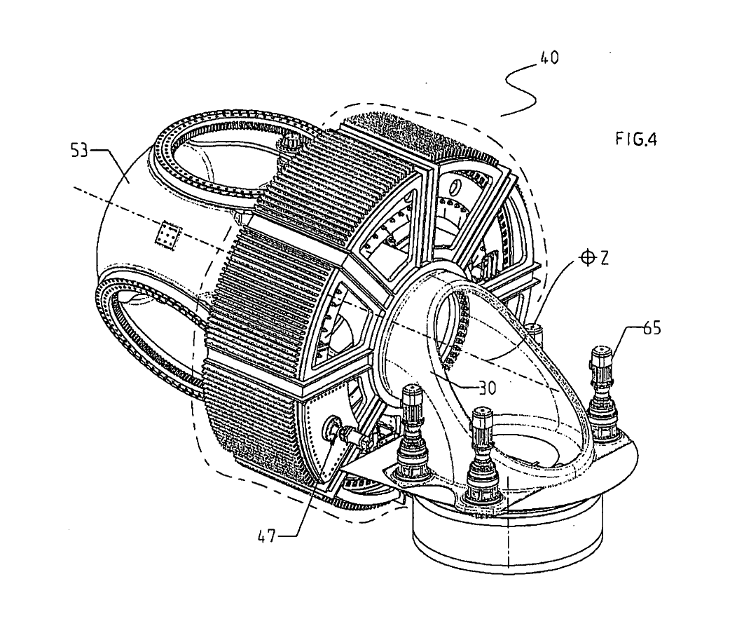

FIG. 4 shows a further detail of a part of the generator in FIG. 1.

With reference to FIG. 1, with 1 is indicated as a whole a wind turbine with an external stator electric generator.

Wind turbine 1 is installed on a tower 20 at the top of which is a shuttle 30 on which an inner rotor electric generator 40 is installed, in turn connected to a wind rotor 50 provided with a plurality of blades 51 radially placed with respect to the hub of the turbine itself.

Between wind rotor 50 and electric generator any multiplication means of the rotation speed is not present; for such a reason wind turbine 1, which is the subject of the present invention, is defined as “gearless”.

Blades 51 of the turbine can be rotated around an orthogonal axis with respect to the axis on which wind rotor 50 rotates; said rotation occurs/through actuators 52 in order to permit to vary the incidence with respect to the wind hitting wind rotor 50 itself; in particular the incidence variation occurs by means of a rotation of blades 51 around a radial axis with respect to the rotary axis of wind rotor 50.

In detail, each blade 51 is actuated and controlled by a respective actuator, such that every single blade can operate also as an aerodynamic brake, for example in case of a too strong wind.

If the wind turbine has a plurality of blades 51, each of them is able to vary its own incidence with respect to the wind, independently from the other ones.

The variation of inclination of blades 51 is made through actuators with motorized reducers and with a pinion and toothed wheel control system or, in alternative, with linear electro-mechanical actuators with recirculation ball screw. Shuttle 30 also rotates on a support bearing with respect to rotation 35, actuated by suitable actuators 65, in order to orientate wind rotor 50 in the desired direction (such rotation is called pitch rotation). The aforesaid orientating actuators 65 are positioned on suitable seats, integral with shuttle frame 32, with a particular care for the access and maintenance spaces inside shuttle 30 itself.

In detail, electric generator 40, of the permanent magnetic kind and with a radial flow, comprises a stator 41 and a rotor 42, coaxially mounted, in which stator 41, of a substantially cylindrical shape, is fixed to shuttle 30, whereas the rotor, positioned inside stator 41, rotates with respect to shuttle 30 and is fixed to a respective bearing 60, of the double row taper roller kind. Both shuttle 30 and generator comprise a respective frame which, in the following description, is indicated respectively as shuttle frame 32 and generator frame 30, respectively fixed one with the other, when wind turbine 1 is mounted.

As shown in greater detail in FIGS. 2 and 3, bearing 60 comprises a coaxially placed first inner ring 61 and a second outer ring 62; the first and second ring 61, 62 are concentric and centred on a Z-axis around which rotor 42 rotates. The first inner ring 61, having a first diameter, is fixed to a generator frame 31, which supports electric generator 40 and joins the same to the tower in a structural symmetric way, with a load distribution avoiding structural deformations of the rotor and stator in function of external loads; such generator frame 31 comprising an inner cylindrical wall 31b (in English also called “main shaft”) and integral with shuttle frame 32 (in English also called “main frame”) and therefore it is stationary with respect to this latter, whereas the second outer ring 62, having a second diameter with a size greater than the first one, rotates with respect to the first one and is fixed on generator rotor, 42 by means of a connection having a first bolted flange 70.

A second bolted flange 71 joins in turn the hub of wind rotor 53 with the rotor structure 42. So, the rotating organs, of the wind turbine, such as hub 53 and rotor structure 42, are fastened to the rotary ring of the bearing, by means of a double bolted flange, assuring the interface and the rigid joint of the cylindrical and planar surfaces for a contact among the various components. So, a greater solidity and robustness are obtained in the whole kinematic-chain of wind turbine 1, with a particular respect to the limit of variation of the electric gap under charge of the generator, and also improving its efficiency.

The second outer ring 62 of the bearing of the wind turbine that is the subject of the present invention therefore realises a coupling of the flanged kind.

The second flange 71 also permits the assembly of wind rotor 50 during the installation in site of the wind turbine, independently from electric generator 40.

Both bolted flanges 70, 71 comprise a plurality of bolts, whose direction of main extension is parallel to the Z-axis and they are placed on the whole circumference of the flanges themselves.

Generator frame 31 is substantially of an annular shape with a hollow interior, and it also comprises an outer cylindrical wall 31a, which externally delimits the same and the seat of electric active parts of electric generator (in particular, active parts of the stator), of an inner wall 31b (main shaft), also cylindrical and concentric with respect to outerwall 31a and a rear wall. Outer rear wall 31a and inner wall 31b individuate a cylindrical recess in which the core of electric generator 40 of wind turbine 1 is positioned.

Walls 31a and 31b identify two cylinders having a common axis, Z-axis, which also is the axis around which it rotates concentrically with outer ring 62 and on which inner ring 61 of bearing 60 is centred.

As can be seen in greater detail in FIG. 4, furthermore the rear wall of electric generator 40 is not full but on the contrary it comprises a plurality of beams radially disposed with respect to Z-axis; such beams permit to join outer wall 31a with inner wall 31b and leave between them apertures which facilitate the cooling of electric generator 40.

On outer wall 31a the core of stator 41 of electric generator 40 is fixed, whereas on inner wall 31b the first inner ring 61 of bearing 60 is fixed. The first inner ring 61 of bearing 60 is made by two parts respectively forming two electric half-bodies. During an assembly phase of electric generator 40 with the rest of wind turbine 1, and in particular in that referring to the assembly of rotor 42 of the electric generator inside generator frame 31, the two symmetrical half-bodies of first inner ring 61 are axially preloaded so generating a high pressure between the rows and the rolling elements of cylindrical shape which mediate the contact between outer rings and inner ring. The second outer ring 62 is instead realized in a single piece.

It has already been said of the cavity present between inner wall 31b and outer wall 31a of generator frame 31; once mounted all parts which are positioned inside electric generator 40, free zones anyhow remain inside which a cooling air flow passes of the electric devices present inside the shuttle, and also for the facility of access and maintenance by qualified operators for the intervention.

Shuttle 30 also internally comprises electromechanical actuators 65 for the orientation of shuttle 30 itself and installed in an outer zone but integral with the frame of shuttle 31, which, being electrically fed, are prone to thermal dissipation and therefore they must be cooled during their operation.

Wind turbine 1 further comprises a static converter of the “back to back” kind (also known, in technical language, with the English term full converter) and a tension-amplifying transformer able to increase a first tension V1 produced by electric generator 40 and present at the ends of a plurality of conductor cable coming out from it, in a second tension V2 of a greater values apt to transmit an electric energy towards the electric network (typically, middle tension).

Finally, wind turbine 1 which is the subject of the present invention comprises a first brake 45 (electromechanical or hydraulic) acting on a braking disc 46 (disc of dynamic braking) connected with rotor 42; in particular the first brake 45 performs the function of hydraulic brake of wind rotor 50; furthermore, wind turbine 1 also comprises a second brake 47 (electromechanical or hydraulic, technically known as parking brake and represented in detail in FIG. 4) acting on the same braking disc 46 (disc of dynamic braking); second brake 47 is instead necessary when one wants to lock the wind rotor in the cases in which the need should arise of an intervention of operators inside wind turbine 1.

The advantages of wind turbine 1 with external stator electrical generator are clear from the preceding description. In particular it firstly permits to pass the efforts deriving from the rotation of wind rotor 50 through bearing 60 which transfers them directly to inner wall 31b which is integral with shuttle frame 32, with the consequent relief of the stresses which otherwise would discharge on the remaining parts of the generator frame 31; therefore such stresses do not directly affect the active parts (rotor 41 and stator 42) of electric generator 40. Wind turbine 1 which is the subject of the present invention is therefore very strong, compact and versatile, does not have constraints limiting its size and permits a more flexible and easier maintenance, characterized by a lower economic outlay.

As a consequence, outer wall 31a (acting as a support of electric generator 40) can be made of a smaller size or in any case slimmer, as such support is just subject to the force of gravity of the active stator parts of electric generator 40′ and to the electromagnetic interaction force between rotor 42 and stator 41 in operation.

Furthermore, having said that in general the dimensions (both in radial and axial terms) of electric generator 40 inevitably depend on the size (and so on the power) of wind turbine 1 as a whole, through wind turbine 1 which is the subject of the present invention no size constraints are present, as it is possible to consider electric generator 40 as an independent element and not directly linked either to the dimensions of shuttle 30 or to those of wind rotor 50.

Furthermore, wind turbine 1 which is the object of the present invention can be produced and divided in four distinct components: wind rotor 50; electric generator assembly 40; shuttle 30 and tower 20. Consequently, the production, transport and installation of the wind turbine which is the subject of the present invention are facilitate by virtue of the splitting of weight so obtainable.

Moreover, having the first inner ring 61 of bearing 60 divided in two distinct parts permits to avoid loss dangers of the preload itself during the operation of wind turbine 1.

The bolted connection flange of second ring 62 of bearing 60 with generator rotor 42 of wind turbine 1 permits a separate assembly of electric generator 40, so that wind turbine 1, obviously without tower 20, can be transported and installed on site without the need of fixing and connection means among the various parts lying on the upper end of tower 20. The configuration of wind turbine 1 which is the subject of the present invention does not entail size constraints of the same. Having a single double-row roller ball bearing, the wind turbine which is the subject of the present invention synergistically combines the simplicity and constructive economy of a single bearing turbine by withstanding heavy radial and axial loads, much greater than those which could be incurred in safety conditions by one or more ball bearings of the same size.

The fact that the second flange 71 permits the assembly of wind rotor 50 in the in site installation step of the wind turbine independently from electric generator 40 produces fewer complications during the logistic steps of transporting and assembling wind turbine 1.

Furthermore, by means of a flanged connection of the rings the danger of fretting corrosion is reduced in the case of elastic deformations during the operation of the wind turbine.

The absence of means for varying the rotation speed which passes between wind rotor 50 and electric generator 40 (as for example a devolution multiplyier), like the absence of the power static converter and of the transformer inside shuttle 30 permits to reduce even more its dimensions and weight, so obtaining a more compact shape.

The control of every single blade 51 of wind rotor 50 in terms of variation of incidence with respect to the wind, further permits to have a reduction and optimization of the loads on bearing 60 and on other structural components of wind turbine 1.

It is finally clear that to the device until now described some changes, improvements and additions can be applied, which are obvious to those skilled in the art without having for this reason to depart from the scope of invention given by the annexed claims.

1. Wind turbine with a radial flow and external stator electric generator, comprising:
a tower,
a shuttle positioned on said tower,
a wind rotor rotating around a rotary axis and having at least one blade hit by a wind flow, and
an electric generator for producing an electric current from said wind flow mounted inside said shuttle; said generator comprising a radial flow generator, comprising a stator and a rotor; said stator being external to said rotor; said wind turbine comprising a single support bearing of said rotor; the wind turbine comprising a generator frame
comprising a first and second ring forming joining means of said wind rotor with said generator frame; said first ring (61) being fixed with respect to said shuttle; said second ring rotating with respect to said shuttle; said bearing being installed on said generator frame symmetrically supporting said generator integral with said shuttle in a releasing position of at least one part of said generator frame from stresses generated by weight and rotation of said wind turbine.

2. A wind turbine according to claim 1, wherein said generator frame comprises an inner wall, an outer wall separated from said inner wall and a rear joining wall between said inner wall and said outer wall.

3. A wind turbine according to claim 2, wherein said outer wall and said inner wall have a cylindrical shape and are concentric and centered on a common Z-axis.

4. A wind turbine according to claim 2 wherein active parts of said electric generator are installed in an area comprised among said outer wall, said inner wall and said rear wall.

5. A wind turbine according to claim 2, wherein said first ring of said bearing is fixed to said inner wall.

6. A wind turbine according to claim 1, wherein wind rotor further comprises a hub connected with said generator; said hub being fixed to said rotor of the generator by a first elementary connection, which in turn is connected with said second ring of said bearing by a second elementary connection.

7. Generator according to claim 3, wherein said first ring and said second ring of said bearing are concentric and centred centered on said axis.

8. A wind turbine according to claim 1, wherein said at least one blade of said wind rotor rotates around a first axis; said first axis being orthogonal to a second axis on which said wind rotor rotates.

9. A wind turbine according to claim 8, wherein said wind rotor comprises a plurality of blades, each of said blades rotating around said first axis independently from the other blades; said turbine also comprising actuator means for the rotation of said blades around said first axis.

10. A wind turbine according to claim 1, wherein said second ring is integrally linked to said generator rotor of said wind turbine through a first bolted flange; said second ring forming a flanged coupling.

11. A wind turbine according to claim 10, also comprising a second bolted flange, said second bolted flange linking said generator rotor to said hub of said wind rotor.

12. A wind turbine according to claim 10, wherein said first and second flange comprise a plurality of bolts disposed parallel to said rotary axis of said wind turbine.

13. A wind turbine claim 1, wherein said bearing comprises a double-row taper-roller bearing.
